(19) United States
(12) Patent Application Publication
(10) Pub. No.: US 2015/0323362 A1
(43) Pub. Date: Nov. 12, 2015

(54) Mass flowmeter

(71) Applicant: Xiaojun SUN, Beijing (CN)

(72) Inventor: Xiaojun Sun, Beijing (CN)

(73) Assignee: Walsn Enterprise Ltd., Richmond, BC (CA)

(21) Appl. No.: 14/649,301

(22) PCT Filed: Dec. 23, 2013
(86) PCT No.: PCT/CN2013/090204

§ 371 Date: Jun. 3, 2015

(30) Foreign Application Priority Data
Dec. 31, 2012 (CN) 201210585479.0

(51) Int. Cl. G01F 1/84; G01F 15/14

(52) U.S. Cl. CPC G01F 1/8413; G01F 15/14; G01F 1/8477; G01F 1/8422

(57) ABSTRACT

A mass flowmeter includes: a casing (18), two U-shaped measurement tubes (1, 2) with identical structures within the casing (18), a vibration exciter (3) installed at a center axis line of the two U-shaped measurement tubes (1, 2), two detectors (4, 5) respectively located at centers of second circular arc segments (22, 23), four distance plates (6, 7, 8, 9), two flanges (10, 11) respectively arranged at two outermost ends of the mass flowmeter symmetrically, two end connecting tubes (12, 13) connected to the U-shaped measurement tubes (1, 2) through two flow dividers (14, 15) which are connected to each other through an intermediate connecting tube (16), and a lead wire connector (17); wherein the two U-shaped measurement tubes (1, 2) are arranged in parallel, each of the U-shaped measurement tubes (1, 2) includes a first circular arc segment (19), wherein both sides of the first circular arc segment (19) are each connected to sloped tube segments (20, 21), the second circular arc segments (22, 23), and straight tube segments (24, 25) in sequence, and left half parts and right half parts of the U-shaped measurement tubes (1, 2) constitute a symmetrical structure relative to a center line of the first circular arc segment (19).

### CROSS REFERENCE OF RELATED APPLICATION

This is a U.S. National Stage under 35 U.S.C. 371 of the International Application PCT/CN2013/090204, filed Dec. 23, 2013, which claims priority under 35 U.S.C. 119(a-d) to CN 201210585479.0, filed Dec. 31, 2012.

### BACKGROUND OF THE PRESENT INVENTION

1. Field of Invention

The present invention relates to a field of test and measurement instruments, and in particular to a new U-shaped Coriolis mass flowmeter.

2. Description of Related Arts

The mass flow measurement technology is an important development point of nations' technology in the process control field. In order to achieve high precision and high reliable measurement on various media under complex environments, Coriolis Mass Flowmeter (CMF) becomes one of the important developing technologies in the field and can meet great needs of the nations due to its superior performance CMF can directly measure the mass flow of the fluid within a pipe with high accuracy, and employ the influence of the Coriolis effect generated when the fluid flows through a vibrating pipe on the vibrating phase or amplitude at the two sides of the pipe to measure the fluid mass flowing through the pipe. CMF has good stability, high reliability and high measurement range, and is suitable for high viscosity fluid.

CMF performs measurement by employing the principle that Coriolis force proportional to the mass flow will be generated when the fluid flows through a vibrating tube. As shown in FIG. 8, the vibrating tube Coriolis mass flowmeter is commonly used, which is composed of a primary instrument and a secondary instrument. The primary instrument a (i.e. sensitive unit of Coriolis mass flow sensor) comprises measurement tubes a1 and a2, a vibration exciter a5, and vibration pickups a3 and a4. The secondary instrument b comprises a closed-loop control unit b1 and a flow computation unit b2 which are the control system and the signal processing system of the primary instrument respectively. The primary instrument (i.e. Coriolis mass flow sensor) is a sensitive unit which outputs a vibrating signal related to the flow being measured. The closed-loop control unit b1 provides a vibration exciting signal to the vibration exciter a5 to keep the measurement tube in a resonant state, and keeps track of the vibrating frequency of the measurement tubes a1 and a2 in real time. The flow computation unit b2 processes the signal outputted from the sensor vibration pickups a3 and a4 and outputs a measurement information from which the mass flow and density of the fluid being measured is determined.

The conventional vibrating tube CMF can be classified into a single tube type and a double tube type based on the configuration of the measurement tube. The single tube type can be easily influenced by outside vibrations, and thus the double tube type is more used. Since the shape of the two tubes is the same, their inherent frequency is close, and they are easily to get vibrated. The flowing condition of the medium being measured within the two tubes is the same, and the phase of the up and down vibration is opposite; therefore, the effect generated by Coriolis force is opposite, and the entire flowmeter is always in a state of force balance. In practice, the distributer at the tube end cannot make sure the flow within the two tubes is absolutely equal; thus the deposit and the abrasion of the two tubes cannot guarantee being absolutely the same. Therefore, the two tubes cannot guarantee being simultaneously cleaned completely when being cleaned. As a result, the offset at zero point will occur during measurement, resulting in additional errors. Currently, most products are still the double tube type which makes it easy to perform phase measurement and is suitable for the current technology and fabrication process level.

CMF can be classified into a curved tube type and a straight tube type. The curved tube type is mainly produced by combining a curved tube segment and straight tube segment. Many curved tube types are disclosed in the prior art such as U-shape, Ω-shape, Δ-shape, circular-shape, C-shape, B-shape, T-shape, water drop-shape, fly-flap-shape and so on. The tube wall of the curved tube type is relatively thick, less rigid, and more immune to abrasion. The resonant frequency thereof is relatively low, and usually at 70-120 Hz. The phase difference reflecting the mass flow is in the level of millisecond, and the electronic signal is easy to be processed. However, the curved tube type is likely to keep gas and fluid residues, which results in additional errors. In addition, the curved tube type is more complex to be fabricated than the straight tube type.

The straight tube typed CMF measurement tube has high resonant frequency and small amplitude (about 60 μm) due to high rigidity. It is not easy to be influenced by outside vibration due to its relatively high frequency which is far from the frequency of a general industrial mechanical vibration. It is not easy to keep gas and the residues and has small profile size. In order to make the resonant frequency not too high, its tube wall is designed to be thin, and about ¼ to ½ of the curved tube. Therefore, it has low capability of preventing abrasion and corrosion. The phase difference reflecting mass is in the level of microsecond, and thus the electric signal is more difficult to be processed, which severely limits the measurement range of the CMF. In addition, the conventional vibrating straight tube typed CMF has low sensitivity, and is not immune to temperature fluctuation. The straight tube typed CMFs or similar CMFs developed and applied around the world are for example disclosed in the patent application CN00129058.4 with the tile of “Coriolis Mass Flowmeter”. The Coriolis mass flowmeter is fabricated as an arch shape curved in one direction. Its structure is usually a curved tube which has low stability of low speed, and the fluid is easy to be attached and deposited at the inner wall of the tube. In addition, its fabrication and installation is complex, and it has poor characteristic of dynamic balance.

Currently, the developed CMF has some restraining factors such as follows. The comprehensive performance of the CMF measurement tube design is low, the tube installation is unstable, and the mechanics of the tube type is difficult to be implemented. CMF is relatively sensitive to outside vibration disturbance. CMF system cannot be used to measure low density medium. When measuring liquid containing gas, the measurement accuracy would be influenced if the contained gas is too much. The measurement tube can be influenced by the design, fabrication and installation process, and it has poor characteristic of dynamic balance, which influences the performance of the CMF directly and irreversibly.

Therefore, it is necessary to design a new U-shaped CMF combining the advantages of the conventional curved tube and the conventional straight tube. The new U-shaped CMF in the present invention is designed in view of the above problems. It has low influence of flow field, low flow resistance, and low pressure loss, and it can be easily fabricated and installed. The measurement tube has good characteristic of dynamic balance. The CMF has high comprehensive performance and wide measurement range. It can measure mass flow of liquid with high viscosity and high impurity content. The types of CMF products are broadened, and the core competence is enhanced.

### SUMMARY OF THE PRESENT INVENTION

In view of the above, an object of the present invention is to provide a new U-shaped CMF, wherein the new U-shaped CMF is able to reduce influence of a flow field, and has low flow resistance and low pressure loss. The CMF is able to be easily fabricated and installed, and a measurement tube thereof has good characteristic of dynamic balance. The CMF is able to measure mass flow of liquid with a high viscosity and a high impurity content, and the CMF has increased comprehensive performance and measurement range.

Accordingly, in order to accomplish the above object, the present invention provides:

a mass flowmeter, comprising: a casing (18), two U-shaped measurement tubes (1, 2) with identical structures within the casing (18), a vibration exciter (3) installed at a center axis line of the two U-shaped measurement tubes (1, 2), two detectors (4, 5) respectively located at centers of second circular arc segments (22, 23), four distance plates (6, 7, 8, 9), two flanges (10, 11) respectively arranged at two outermost ends of the mass flowmeter symmetrically, two end connecting tubes (12, 13) connected to the U-shaped measurement tubes (1, 2) through two flow dividers (14, 15) which are connected to each other through an intermediate connecting tube (16), and

a lead wire connector (17); wherein the two U-shaped measurement tubes (1, 2) are arranged in parallel, each of the U-shaped measurement tubes (1, 2) comprises a first circular arc segment (19), wherein both sides of the first circular arc segment (19) are each connected to sloped tube segments (20, 21), the second circular arc segments (22, 23), and straight tube segments (24, 25) in sequence, and left half parts and right half parts of the U-shaped measurement tubes (1, 2) constitute a symmetrical structure relative to a center line of the first circular arc segment (19).

Preferably, the vibration exciter (3) comprises a coil and a magnet in cooperation, and is installed at the center axis line of the two U-shaped measurement tubes (1, 2), the coil of the vibration exciter (3) is installed on one of the U-shaped measurement tubes (1) through a fastener, and the magnet of the vibration exciter (3) is installed on the other of the U-shaped measurement tubes (2).

Preferably, the two detectors (4, 5) comprise coils and magnets in cooperation coaxially, and are located at the centers of the second circular arc segments (22, 23).

Preferably, two ends of each of the two parallel U-shaped measurement tubes (1, 2) are respectively soldered with two distance plates, and the four distance plates fix the two parallel U-shaped measurement tubes (1, 2).

Preferably, the casing (18) is fixed with outer end faces of the flow dividers (14, 15) at two sides by soldering.

Preferably, the two flanges (10, 11) are respectively arranged at the outermost ends of the mass flowmeter symmetrically, and are respectively fabricated with the two end connecting tubes (12, 13) in a manner of integral molding.

Preferably, distance plates at both ends of the U-shaped measurement tubes (1, 2) are located at the straight tube segments (24, 25) of the U-shaped measurement tubes (1, 2), and are perpendicular to the straight tube segments (24, 25).

Preferably, a center spacing of the two parallel U-shaped measurement tubes (1, 2) is 2.5D-3D, wherein D is an outer diameter of each of the U-shaped measurement tubes (1, 2).

Preferably, there are two holes in each of the distance plates, a size of each of the holes is same as the outer diameter D of each of the U-shaped measurement tubes (1, 2), a distance between the two holes is 2.5D-3D, and the distance plates are fixed to the U-shaped measurement tubes (1, 2) by vacuum brazing.

In general, compared with the prior art, the present invention has the following advantages.

(1) The present invention employs a new U-shaped tube form. The structure improves the performance of the resonant sensor and the mechanical quality factor effectively, and reduces the influence of the flow field drastically. The present invention has low flow resistance and low pressure loss, which is able to measure mass flow of liquid with high viscosity and high impurity content, and is able to be easily fabricated with low cost. As a result, the comprehensive performance and the measurement range of the CMF are improved.

(2) The present invention adopts a duple distance-fixing mode, that is, both sides of the measure tubes employ two distance plates respectively, and the measurement tubes are fixed to the distance plates by vacuum brazing. The best installation positions of the distance plate in the present invention are determined by modal analysis and harmonic response analysis in the finite element analysis, and are both at the straight tube segments of the U-shaped measurement tubes and perpendicular to the straight tube segments, which enables the measurement tubes to have high resonant frequency, high stability, and strong quaking resistance.

(3) The vibration exciter and the detectors of the present invention are both used with the coil and the magnet in cooperation. The vibration exciter is installed at the center of the first circular arc segments of the two facing measurement tubes, and the detectors are located at the centers of the second circular arc segments of the measurement tubes. The vibration exciter and the detectors together form a good closed-loop system for enabling the Coriolis sensor flow tubes to have stable working state, low influence from the outside disturbance, and strong self-adjustment capability.

### BRIEF DESCRIPTION OF THE DRAWINGS

FIG. 1 is a structural schematic diagram of a new U-shaped CMF of the present invention.

FIG. 2 is a front view of a structure of the new U-shaped CMF of the present invention.

FIG. 3 is a bottom view of the structure of the new U-shaped CMF of the present invention.

FIG. 4 is a schematic diagram of a mechanical structure of one new U-shaped measurement tube of the present invention.

FIG. 5 is a schematic diagram of an installation structure of an exciter and a detector of the present invention.

FIG. 6 is a schematic diagram of an installation structure of duple distance plates of the present invention.

FIG. 7 is a structural schematic diagram of a distance plate of the present invention.

FIG. 8 is a structural diagram of a typical conventional CMF system with double U-shaped tubes.

### DETAILED DESCRIPTION OF THE PREFERRED EMBODIMENT

Referring to the drawings, preferred embodiments of the present invention are further illustrated.

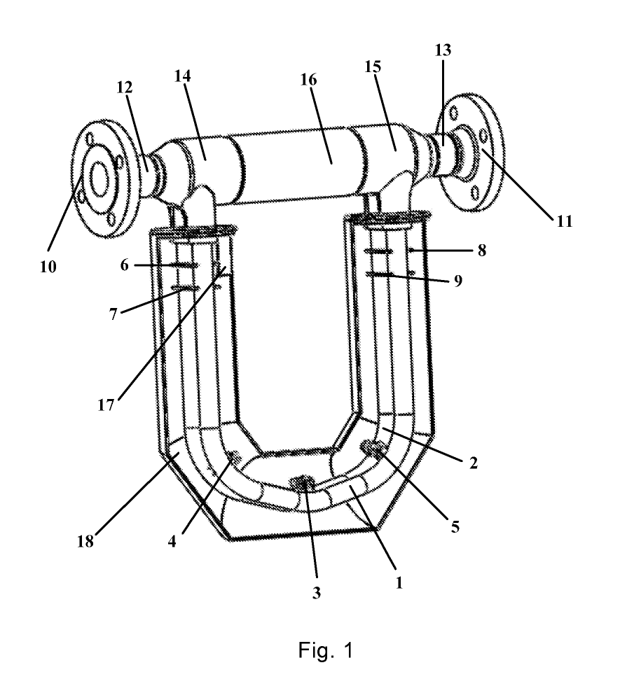

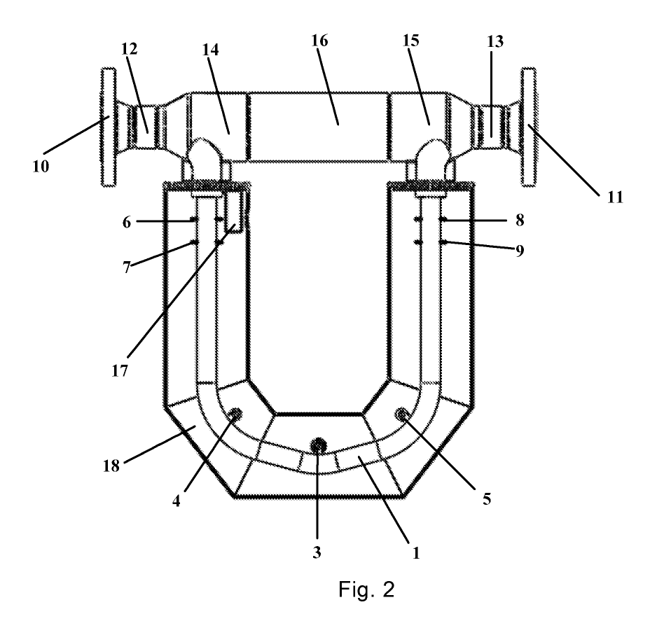

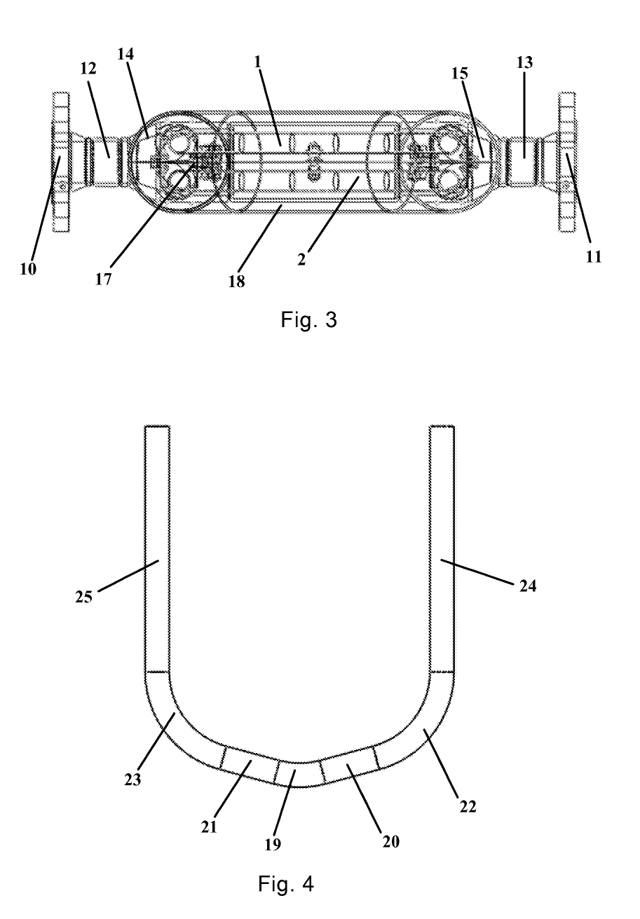

As shown in FIG. 1, a new U-shaped CMF of the present invention comprises two new U-shaped measurement tubes 1 and 2 with identical structures and sizes, a vibration exciter 3, two detectors 4 and 5, four distance plates 6, 7, 8 and 9, two flanges 10 and 11, two end connecting tubes 12 and 13, two flow dividers 14 and 15, one intermediate connecting tube 16, and a casing 18.

The two flanges 10 and 11 are respectively located at two outermost ends of the new U-shaped CMF. The two end connecting tubes 12 and 13 are respectively fabricated with the two flanges 10 and 11 in a manner of integral molding. Parts between the two end connecting tubes 12 and 13 and the two U-shaped measurement tubes 1 and 2 are referred to as the flow dividers 14 and 15. The two flow dividers 14 and 15 distribute a process medium to the two measurement tubes uniformly. The measurement tube with double flow paths performs flow dividing and flow merging by the flow dividers 14 and 15 at an input segment and an output segment. The U-shaped measurement tubes 1 and 2 are fixedly soldered with the four distance plates 6, 7, 8 and 9 at both sides. The two U-shaped measurement tubes 1 and 2 are parallel soldered to outer end faces of the flow dividers 14 and 15 firmly, and are connected to the end connecting tubes 12 and 13. The casing 18 is fixed by soldering to the outer end faces of the flow dividers 14 and 15 at two ends, and has functions of support, protection and vibration isolation.

It is supposed that the fluid to be measured flows in from a left side and flows out from a right side. The fluid to be measured enters the flow divider 14 through the input end connecting tube 12 connected via the flange 10, and is equally divided into two paths of fluid to enter the two U-shaped measurement tubes 1 and 2. At the other side, the two paths of fluid merges through the flow divider 15 into the output end connecting tube 13 connected via the flange 11.

As shown in FIG. 1, the two U-shaped measurement tubes 1 and 2 vibrate with inherent frequencies thereof and opposite vibration phases under excitation of the electromagnetic exciter 3. The two detectors 4 and 5 (which are electromagnetic detectors) located at a flow input side and a flow output side of the two U-shaped measurement tubes 1 and 2 detect two paths of vibration signals whose phase difference is proportional to a degree of torsion pendulum, i.e., an instantaneous flow. The mass flow is able to be calculated by calculating the phase difference between the signals.

The vibration exciter 3 is installed at a center axis line of the measurement tubes. A coil of the vibration exciter 3 is installed on one of the U-shaped measurement tubes through a fastener, and a magnet of the vibration exciter 3 is installed on the other of the U-shaped measurement tubes. The vibration exciter 3 is used to excite the vibration of the measurement tubes, and makes the measurement tubes in a state of simple harmonic vibration through a closed-loop control system. The vibration exciter 3 employed by the present invention is used with the coil and the magnet in cooperation to enable the CMF tubes to vibrate with the inherent frequency thereof. The coil and the magnet are respectively installed at centers of first circular arc segments 19 of the two facing measurement tubes.

The detectors 4 and 5 are used with coils and magnets coaxially in cooperation, are installed at center positions of circular arc tube segments 22 and 23 at upper two sides of the two parallel U-shaped measurement tubes 1 and 2, and are symmetric to each other with respect to a center of the two parallel U-shaped measurement tubes 1 and 2.

As shown in FIG. 4, a middle of each of the two U-shaped measurement tubes 1 and 2 of the present invention is the first circular arc segment 19, both sides of the first circular arc segment 19 are each connected to a sloped tube segment 20 or 21, the second circular arc segment 22 or 23, and a straight tube segment 24 or 25 in sequence, and a left half part and a right half part constitute a symmetrical structure relative to a center line of the first circular arc segment 19. All the parts make transitions through smooth circular arcs, reducing the influence of a flow field and lowering the flow resistance. The sloped tube segments 20 and 21 of the two U-shaped measurement tubes 1 and 2 are able to improve Coriolis effect, sensitivity and measurement range. The structure has the advantages such as simple structure, small volume, easy cleaning, small abrasion, and so on, and is easy for self emptying and cleaning. Therefore, it is possible to measure mass flows of oil, slurry or the like with high viscosity and impurity content.

A tube material for the two U-shaped measurement tubes 1 and 2 usually adopts 316L stainless steel, titanium, Hastelloy alloy, and other materials. The present invention does not have high requirement on the tube materials, and thus it is possible to use low cost 316L stainless steel tubes. The measurement tubes 1 and 2 of the present invention are parallel to each other, an outer diameter thereof is D, and a spacing between the centers of the two parallel measurement tubes is 2.5D-3D.

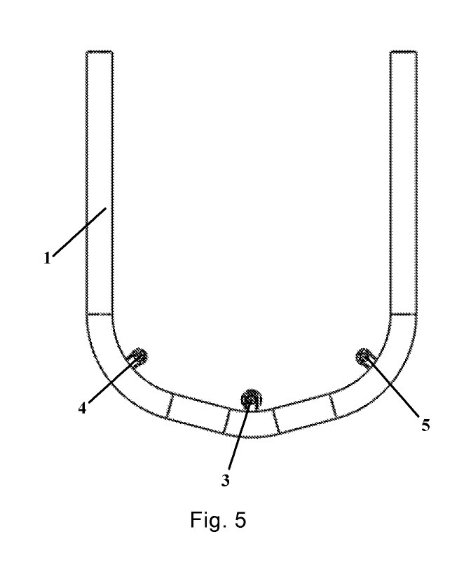

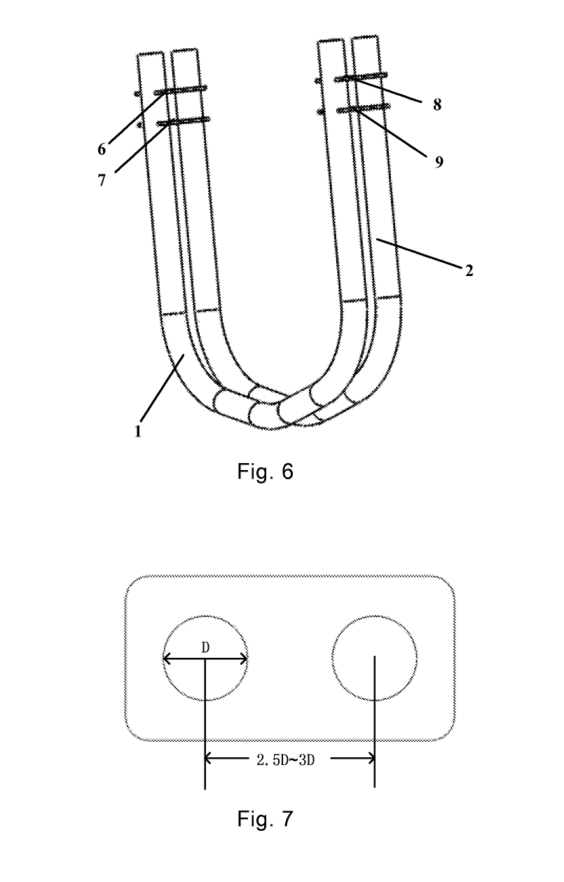

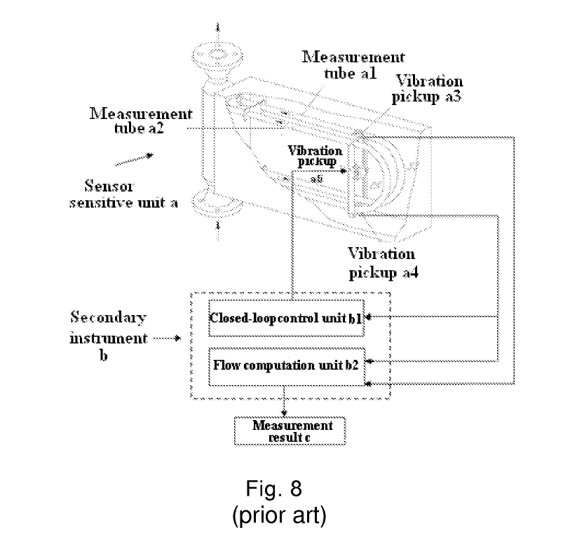

As shown in FIG. 5 and FIG. 6, the vibration exciter 3 of the present invention is installed at the center axis line of the measurement tubes. The detectors 4 and 5 are respectively located at the centers of the circular arc tube segments 22 and 23 at the upper two sides of the two parallel U-shaped measurement tubes 1 and 2, and are symmetrical to each other with respective to the center of the two parallel U-shaped measurement tubes 1 and 2. A best installation position of the distance plates 6, 7, 8 and 9 at both sides of the U-shaped measurement tubes 1 and 2 is where the two pairs of the distance plates are all located at the straight tube segments 24 and 25 of the U-shaped measurement tubes 1 and 2, and perpendicular to the straight tube segments 24 and 25.

As shown in FIG. 6, the distance plates 6, 7, 8, 9 are employed respectively at both sides of the U-shaped measurement tubes 1 and 2. The distance plates fix the two U-shaped measurement tubes 1 and 2 at the same time by vacuum brazing, and would not result in deformation, making the two U-shaped measurement tubes 1 and 2 have identical characteristics while providing limited torsion and bending necessary for flow measurement. Changing in the position of the duple distance plates at the straight tube segments would change a resonant frequency of the sensor. Therefore, the position of the duple distance plates at the straight tube segments is able to be determined according to a designed frequency, reducing internal vibration coupling of the measurement tubes and making the measurement tubes have strong quaking resistance.

A principle of the present invention is as follows. According to the Coriolis effect, the two U-shaped measurement tubes 1 and 2 are fixedly soldered with the duple distance plates at both sides of the measurement tubes, and the two measurement tubes are soldered parallel and firmly to the outer end faces of the flow dividers 14 and 15 and are connected with the end connecting tubes 12 and 13, constructing a tuning fork to eliminate the influence of the outside vibration. The two measurement tubes vibrate with the inherent frequency thereof and opposite vibration phases under the excitation of the electromagnetic exciter 3. Each fluid element flowing within the tube obtains Coriolis acceleration due to the vibration effect of the measurement tubes, and thus the measurement tubes are imposed with a Coriolis force with a direction opposite to the Coriolis acceleration. Since the output side and the input side of the U-shaped measurement tubes receive the Coriolis forces with opposite directions, the measurement tubes become distorted, and a torsion degree is inversely proportional to the torsion rigidity of the tubes and proportional to the instantaneous mass flow within the tubes. The two electromagnetic detectors located at the flow input side and the flow output side of the measurement tubes detect two paths of the vibration signals during one vibration period of the tuning fork. The phase difference between the paths of signals is proportional to the degree of the torsion pendulum, i.e., the instantaneous flow. The mass flow is able to be calculated by computing the phase difference between the signals.

As shown in FIG. 7, there are two holes in each of the distance plates, wherein a size of each of the holes is same as the outer diameter D of the U-shaped measurement tube 1 or 2 of the present invention. A distance between the two holes equals to the distance between the U-shaped measurement tubes 1 and 2, and is usually 2.5D-3D.

It will thus be seen that the objects of the present invention have been fully and effectively accomplished. One skilled in the art will understand that the embodiment of the present invention as shown in the drawings and described above is exemplary only and not intended to be limiting. Therefore, this invention includes all modifications encompassed within the spirit and scope of the following claims.

What is claimed is:

1. A mass flowmeter, comprising:
a casing (18),
two U-shaped measurement tubes (1, 2) with identical structures within the casing (18),
a vibration exciter (3) installed at a center axis line of the two U-shaped measurement tubes (1, 2),
two detectors (4, 5) respectively located at centers of second circular arc segments (22, 23),
four distance plates (6, 7, 8, 9),
two flanges (10, 11) respectively arranged at two outermost ends of the mass flowmeter symmetrically,
two end connecting tubes (12, 13) connected to the U-shaped measurement tubes (1, 2) through two flow dividers (14, 15) which are connected to each other through an intermediate connecting tube (16), and
a lead wire connector (17);
wherein the two U-shaped measurement tubes (1, 2) are arranged in parallel,
each of the U-shaped measurement tubes (1, 2) comprises a first circular arc segment (19),
wherein both sides of the first circular arc segment (19) are each connected to sloped tube segments (20, 21), the second circular arc segments (22, 23), and straight tube segments (24, 25) in sequence, and
left half parts and right half parts of the U-shaped measurement tubes (1, 2) constitute a symmetrical structure relative to a center line of the first circular arc segment (19).

2. The mass flowmeter, as recited in claim 1, wherein the vibration exciter (3) comprises a coil and a magnet in cooperation, and is installed at the center axis line of the two U-shaped measurement tubes (1, 2), the coil of the vibration exciter (3) is installed on one of the U-shaped measurement tubes (1) through a fastener, and the magnet of the vibration exciter (3) is installed on the other of the U-shaped measurement tubes (2).

3. The mass flowmeter, as recited in claim 1, wherein the two detectors (4, 5) comprise coils and magnets in cooperation coaxially, and are located at the centers of the second circular arc segments (22, 23).

4. The mass flowmeter, as recited in claim 1, wherein two ends of each of the two parallel U-shaped measurement tubes (1, 2) are respectively soldered with two distance plates, and the four distance plates fix the two parallel U-shaped measurement tubes (1, 2).

5. The mass flowmeter, as recited in claim 1, wherein the casing (18) is fixed with outer end faces of the flow dividers (14, 15) at two sides by soldering.

6. The mass flowmeter, as recited in claim 1, wherein the two flanges (10, 11) are respectively arranged at the outermost ends of the mass flowmeter symmetrically, and are respectively fabricated with the two end connecting tubes (12, 13) in a manner of integral molding.

7. The mass flowmeter, as recited in claim 1, wherein distance plates at both ends of the U-shaped measurement tubes (1, 2) are located at the straight tube segments (24, 25) of the U-shaped measurement tubes (1, 2), and are perpendicular to the straight tube segments (24, 25).

8. The mass flowmeter, as recited in claim 1, wherein a center spacing of the two parallel U-shaped measurement tubes (1, 2) is 2.5D-3D, wherein D is an outer diameter of each of the U-shaped measurement tubes (1, 2).

9. The mass flowmeter, as recited in claim 8, wherein there are two holes in each of the distance plates, a size of each of the holes is same as the outer diameter D of each of the U-shaped measurement tubes (1, 2), a distance between the two holes is 2.5D-3D, and the distance plates are fixed to the U-shaped measurement tubes (1, 2) by vacuum brazing.
